(19) United States
(12) Patent Application Publication
(10) Pub. No.: US 2024/0208180 A1
(43) Pub. Date: Jun. 27, 2024

(54) COMPOSITE STRUCTURE MADE OF TITANIUM AND/OR A TITANIUM ALLOY AND/OR NITI AND A POLYMER, AND ELECTROCHEMICAL ETCHING METHOD FOR PRODUCING SAME

(71) Applicant: Christian-Albrechts-Universitaet zu Kiel, Kiel (DE)

(72) Inventors: Mark-Daniel Gerngross, Reutlingen (DE); Melike Baytekin-Gerngross, Reutlingen (DE); Juergen Carstensen, Kiel (DE); Rainer Adelung, Kiel (DE)

(21) Appl. No.: 18/288,477

(22) PCT Filed: Apr. 19, 2022
(86) PCT No.: PCT/DE2022/100296

§ 371 Date: Oct. 26, 2023

(30) Foreign Application Priority Data
Apr. 29, 2021 (DE) 10 2021 111 147.1

(51) Int. Cl. B32B 15/08; B32B 3/30; B32B 7/08; C25F 3/08

(52) U.S. Cl. CPC B32B 15/08; B32B 3/30; B32B 7/08; C25F 3/08; B32B 2250/02; B32B 2250/03; B32B 2250/40; B32B 2307/7376; B32B 2311/18; B32B 2311/22

(57) ABSTRACT

A composite structure having —at least a first partial surface of a structure and/or of a workpiece and/or of a layer comprising titanium and/or a titanium alloy and/or NiTi, —a polymer which is arranged at least partially or in sections on the first partial surface of the first structure and/or of the workpiece and/or of the layer, —a common anchoring layer, wherein —the polymer is bonded in the contact region to the titanium and/or to the titanium alloy and/or NiTi at least partially or in sections or in the region of the first partial surface, completely or entirely via the common anchoring layer. Furthermore, the invention relates to an electrochemical etching method for producing undercut structures on surfaces of titanium and/or titanium alloys and/or NiTi for mechanical coupling of a polymer to produce a composite structure.

The invention relates to a composite structure having
at least a first partial surface of a structure and/or of a workpiece and/or of a layer comprising titanium and/or a titanium alloy and/or NiTi,
a polymer which is arranged at least partially or in sections on the first partial surface of the first structure and/or of the workpiece and/or of the layer,
a common anchoring layer, wherein
the polymer is bonded in the contact region to the titanium and/or to the titanium alloy and/or NiTi at least partially or in sections or in the region of the first partial surface, completely or entirely via the common anchoring layer.

Furthermore, the invention relates to an electrochemical etching method for producing undercut structures on surfaces of titanium and/or titanium alloys and/or NiTi for mechanical coupling of a polymer to produce a composite structure.

At this point it is pointed out that the subject matter of the invention relates or can relate to titanium, titanium alloys and furthermore also in particular to NiTi, whereby this can also be meant if only one of the previously mentioned is mentioned below.

Workpieces made of titanium and/or titanium alloys with conditioned surfaces have a very wide range of applications.

Titanium and titanium-based alloys are used for particularly stressed parts in aircraft, steam turbines, spacecraft, machine tools, sports articles and protective equipment, among other things, because of their high strength combined with comparatively low weight (titanium is a light metal). Due to their good salt and corrosion resistance, they are also suitable for ship propellers and parts of seawater desalination plants.

Because of their extremely good biological compatibility (no immunological rejection reaction), titanium and titanium-based alloys are used in medicine, e.g. for endoprostheses and as dental implants. A special case of a titanium alloy is nitinol (NiTi), which is used for medical stents, for example.

In all applications, the targeted conditioning of the surface also plays a role for the purpose of bonding with other materials.

For the composites according to the invention, various fields of application such as medical technology (Ti implants with e.g. silicone coating, silicone-coated NiTi wires for orthodontic applications), aerospace and automotive (active deformation of components by NiTi polymer composites) are useful and promising.

The invention deals with the electrochemical patterning of titanium and titanium alloy surfaces for titanium/titanium alloy polymer composites bonded together by undercut structures in the titanium/titanium alloy component via mechanical interlocking. For a detailed concept of mechanical interlocking via nanoscale sculpturing, the reader is referred to “Nanoscale sculpturing of metals and its applications, Making metal surfaces strong, resistant, and multifunctional by nanoscale-sculpturing,” Nanoscale Horizons 1(6):467-472, DOI: 10.1039/C6NH00140H, Baytekin Gerngross and sources cited in this publication.

The exact technical description of the aforementioned article can also be found in these documents, along with a manufacturing process to achieve this article/surface. This also includes electrochemical anodization of Ti/Ti alloys, oxide film build-up of thick layers in μm scale as well as pores and nanotubes.

In the following, the known and relevant prior art is described in detail, whereby the differences to the present invention are already dealt with in detail:
EP 3 175 018 B1 or WO 2016/015720 A1:

From the prior art, the creation of surfaces on metallic workpieces with improved adhesion for organic polymers and/or biological materials and/or ceramic materials is known from EP 3 175 018 B1 or WO 2016/015720 A1. Herein, a surface-treated metallic workpiece made of titanium and/or titanium alloys with titanium as the main component and/or nickel-titanium alloys as well as nitinol is disclosed, wherein the metal at the treated surface is free of inclusions, precipitates of other metals, accumulations of alkali metals, alkaline earth metals and/or aluminum, intermetallic phases, and/or mechanically highly defective areas, and the surface has a first roughness and a second roughness, the first roughness being given by depressions in the form of pores, the pores having a diameter in the range between 0.5 and 50 μm, being open in the direction of the surface and closed in the direction of the workpiece, and at least some of the pores having an undercut and the second roughness being given by statistically distributed elevations and depressions in the range of 100 nm and less. EP 3 175 018 B1 resp. WO 2016/015720 A1 each disclose a surface-treated metallic workpiece made of titanium and/or titanium alloys with titanium as the main constituent and/or nickel-titanium alloys as well as nitinol, wherein the metal at the treated surface is free of inclusions, precipitates of other metals, deposits of alkali metals, alkaline earth metals and/or aluminum, intermetallic phases, and/or mechanically strongly defective areas, and the surface has a first roughness and a second roughness, the first roughness being given by depressions in the form of pores, the pores having a diameter in the range between 0.5 and 50 μm-being open in the direction of the surface and closed in the direction of the workpiece, and at least some of the pores having an undercut and the second roughness being given by statistically distributed elevations and depressions in the range of 100 nm and less (cf. Claim 1, Abstract). The following similarities are present between the present composite structure according to the invention and the surface-treated metallic workpiece according to the document, namely: Both arrangements have a surface made of titanium and/or a titanium alloy and/or NiTi. In addition, depressions of a similar size are present in both layer surfaces. Thus, on this side, according to the invention, roundish depressions with undercut with a minimum size of 1 μm are present (cf. claim 1 “ . . . any cut surface extending perpendicularly to the anchoring layer has at least one protrusion of polymer enclosed by titanium and/or titanium alloy and/or NiTi, these enclosed protrusions exhibiting a roundish oval shape with a minimum size of 1 μm, . . . ”) and, according to the document, depressions in the form of pores (cf. Claim 1 “ . . . the first roughness is in the form of pores, the pores having a diameter in the range between 0.5 and 50 μm . . . ”).

In addition, both arrangements are free of foreign metals on the metal surface (cf. this application, claim 1 “ . . . at most titanium and/or the aforementioned solid solutions including the intermetallic phases of the titanium alloy and/or NiTi from the bulk material occur in the anchoring layer . . . ”, cf. Claim 1 “ . . . the metal at the treated surface is free of inclusions, precipitates of other metals, deposits of alkali metals, alkaline earth metals and/or aluminum, intermetallic phases and/or mechanically highly defective areas, . . . ”).

However, there are significant differences between the subject matter of the present disclosure and the EP 3 175 018 B1 or WO 2016/015720 A1.

The main differences between the composite structure according to the present invention and the surface-treated metallic workpiece according to the publication are listed below:

On this side, a composite structure with at least a first partial surface of titanium and/or a titanium alloy and/or NiTi with a polymer arranged on this partial surface is claimed, wherein an anchoring layer is formed in the contact region of the two materials. In contrast, in the document, a metallic workpiece made of titanium and/or a titanium alloy and/or NiTi is present and no further structures are claimed (cf. claim 1). Thus, no composite structure is built up and consequently no anchoring layer is present.

In particular, the first partial surface of titanium and/or a titanium alloy and/or NiTi is free of hydrogen-containing phases on this side according to the invention, at least in the region of the anchoring layer, so that no brittle fracture occurs under load. The mechanical properties of the structure are clearly improved by this. This important characterizing feature is not present in the publication. If a polymer is added to a titanium surface according to the publication, adhesive failure at the interface is possible due to hydrogen-induced corrosion at the titanium surface occurring during the surface treatment of the titanium, i.e. the etching process, or brittle fracture occurs near the interface in the titanium/titanium alloy due to hydrogen embrittlement. This leads in particular to hydrogen embrittlement, as negatively charged hydrogen ions thus diffuse into the material. The metallic workpiece according to the publication is not free of hydrogen-containing phases, at least in the area of the metal surface.

In addition, on this side according to the invention, the feature “ . . . any cut surface running perpendicular to the anchoring layer has at least one protuberance of polymer enclosed by titanium and/or titanium alloy and/or NiTi, these enclosed protuberances exhibiting a rounded oval shape with a minimum size of 1 μm, the surface . . . ” is given.

The metallic workpiece according to EP 3 175 018 B1 or WO 2016/015720 A1 has pores on the surface-treated titanium surface, as shown previously. These pores are open in the direction of the surface and closed in the direction of the workpiece, and at least some of the pores have an undercut, as can be seen from the figures and the accompanying figure descriptions. Claim 1 of the specification reads “ . . . and at least a portion of the pores have an undercut . . . ”. It follows from this that pores without undercut are also present in no small number (cf. p. 3, lines 18-30, “ . . . and where at least 25%, preferably 50% of the pores have an undercut . . . ”). Pores without an undercut have a shell-like shape according to the publication, but not a rounded oval shape. If only 25% or preferably 50% of the pores with undercut are present in a workpiece according to the description of the publication, it is no longer mandatory that the characterizing feature according to the present invention “ . . . any cut surface running perpendicular to the anchoring layer has at least one protuberance of polymer enclosed by titanium and/or titanium alloy and/or NiTi, these enclosed protuberances exhibiting a rounded oval shape with a minimum size of 1 μm, the surface . . . ” from the main claim of the composite structure according to the invention is fulfilled. Depending on the pore distribution, there may also be analogous cut surfaces with only pores without undercuts in the titanium surface of the publication, whereby the characterizing feature of roundish oval pores (i.e. pores with undercuts) in any cut surface running perpendicular to the anchoring layer is not applicable to the surface of the publication.
LU et al—Preparation of Superoleophobic and Superhydrophobic Titanium Surfaces via an Environmentally Friendly Electrochemical Etching:
LU, Yao [et al]: Preparation of Superoleophobic and Superhydrophobic Titanium Surfaces via an Environmentally Friendly Electrochemical Etching. In: ACS Sustainable, Vol. 1, 2013, pp. 102-109.—ISSN 2168-0485. DOI: 10.1021/sc3000527 discloses an economical and environmentally friendly electrochemical etching method to prepare superoleophobic and superhydrophobic titanium surfaces. Scanning electron microscopy, X-ray diffraction, Fourier transform infrared spectrophotometry, energy dispersion spectroscopy, and optical contact angle measurements are used to characterize the surface morphology, crystal structures, chemical composition, and wettability of the surfaces to both water and oil.

The paper discloses an economical and environmentally friendly electrochemical etching process for the preparation of superoleophobic and superhydrophobic titanium surfaces. Scanning electron microscopy (SEM), X-ray diffraction (XRD), Fourier transform infrared spectrophotometry (FTIR), energy dispersive spectroscopy (EDS), and optical contact angle measurements are used to characterize the surface morphology, crystal structures, chemical compositions, and wettability of the surfaces for both water and oil. The effects of electrochemical parameters such as current density, electrochemical etching time, electrolyte temperature, and electrolyte concentration on the surface wettability of water, glycerol, and hexadecane are also investigated. Superoleophobicity and superhydrophobicity can be selectively achieved by varying the electrochemical parameters. The following parameters are used for the etching process: Electrolyte concentration: 0.1-1.0 mol/L with sodium bromide as electrolyte, etching current density: 0.125-1.25 A/cm², process times: 60 seconds-15 minutes, electrolyte temperature: 30-80° C. Following the etching process, the samples are ultrasonically rinsed with deionized water, then dried, and then immersed in a 1.0 percent ethanol solution of fluoroalkylsilane for 2 hours, followed by heating at 80° C. for 15 minutes.

The following similarities are present between the etching method according to the present invention and the etching method according to the publication, namely:

On this side according to the invention, an electrochemical cell is connected with titanium and/or a titanium alloy and/or NiTi component as anode and active electrolyte circulation takes place during patterning. According to the publication, titanium specimens are used as anodes and electrochemical etching is performed under magnetic stirring (cf. p. 104, left column, section “Specimen Preparation”). They are not the same thing, since recirculation is rather something technically different from stirring.

The differences between the etching process according to the present invention and the etching process according to the publication are shown below, namely:

According to this side of the invention, an aqueous electrolyte solution with a chlorine ion concentration with a concentration or equivalent concentration of 3 to 7% by weight of NaCl in water or 5% by weight of NaCl in water is used for the etching process. In print, a 0.1 to 1.0 mol/L sodium bromide solution is applied.

Furthermore, according to the present invention, a current density in the range of 1 A/cm² or greater is used. The current density range according to the publication is in the range of 0.125 to 1.25 A/cm². For example, in the experiments for surface characterization in the publication, a current density of 1.0 A/cm² is used to produce a superoleophobic titanium surface (see p. 104, left column, section “Surface Characterization”) and a current density of 0.25 A/cm² is used to produce a superhydrophobic titanium surface (see p. 104, right column, section “Surface Characterization”, upper half). According to the LU et al. publication, working in a current density range in accordance with the method of the present invention is thus possible, but not necessary, in order to achieve the result desired for the investigations of the publication. Through experiments, it was found in the publication that with increasing current density, the electrochemical etch mass per unit time increases, which contributes to the formation of rough micro/nanometer structures on the Ti surface (see p. 107, left column).

In particular, the etching process times differ in the two methods. While on this side of the invention etching process times in the range of 1 to 60 seconds or in the range of 10 to 40 seconds or in the range around 30 seconds are assumed, the etching process times according to the publication YU et al. are in the range of 1 to 15 minutes. Looking at the experiments presented in the publication, it is clear that the etching process times applied are well above one minute. For example, on p. 104, section “Surface, Characterization”, etching process times of 10 minutes each are given for the production of superoleophobic and superhydrophobic titanium surfaces. Also on p. 106, right column, section “Effects of Various Experimental Parameters” the titanium surfaces are etched for a duration of 10 minutes. In FIG. 8 of the publication (Relationship of electrochemical etching duration to contact angles and roll angles of water, glycol, hexadecane) and the corresponding description on pp. 107/108, it is shown that at a current density of 1 A/cm², at an electrolyte temperature of 60 to 70° C. and a 0.2 mol/l sodium bromide solution, a superhydrophobic surface with rough micro/nanometer structures is obtained after an etching time of 6 minutes and a superoleophobic surface is obtained after an etching time of 10 minutes and subsequent fluoroalkylsilane treatment, since re-entrant geometries develop from the rough micro/nanometer structures. The electrochemical etch mass generally increases as the etch time increases. Thus, etch times of several minutes are required to produce superoleophobic and superhydrophobic titanium surfaces.

With the etching process according to the publication YU et al. no structure is obtained according to the structure according to the present invention with a first partial surface of titanium and/or titanium alloy and/or NiTi which is free of hydrogen-containing phases at least in the region of the anchoring layer, i.e. correspondingly in the surface region of the titanium body. On p. 105, left column, the brochure shows how titanium oxidation is followed by titanium hydrolysis and that hydrogen is formed from the sodium bromide solution and absorbed into the titanium matrix (“ . . . H2 was produced from the solution, and the hydrogen atom was then absorbed into the Ti matrix . . . ”). This in turn leads to hydrogen embrittlement.

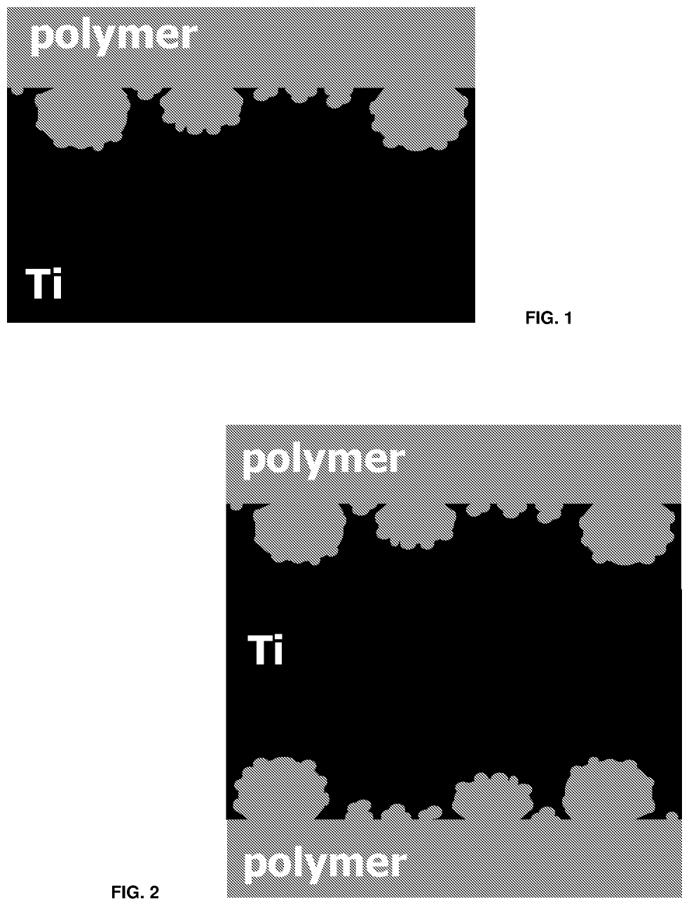

In particular, the surface structure of the titanium surface according to the invention on this side after the etching process also differs significantly from the structure obtained according to the publication. FIG. 1 of the publication shows SEM images of superoleophobic titanium surfaces after the etching process (FIGS. 1a-1c) and of superhydrophobic titanium surfaces after the etching process (FIGS. 1d-1f). It is clear that the images do not show predominant indentations with a rounded oval shape with a minimum size of 1 micrometer corresponding to the structure according to the present invention, with the surface having either smooth or scale-like surface texturing. FIG. 1a shows protrusions in the micrometer range and pores. FIG. 1b shows needle-like structures in the nanometer range. There are again protruding geometries, but not provided with the characteristic feature on this side, adapted analogously from the polymer to the titanium surface, “each cut surface running perpendicular to the titanium surface has at least one indentation with a rounded oval shape and a minimum size of 1 micrometer”. FIG. 1d shows mastoids on the etched titanium surface and FIG. 1e shows nanoflocks, but no re-entrant geometries, which is contrary to the invaginations in the titanium surface according to the present invention (see also Figure Description, p. 104, section “Surface Characterization”). Without protuberances in the titanium surface, the possibility of having polymer protuberances in an anchoring layer is eliminated.
DE 10 2006 004 653 A1:

DE 10 2006 004 653 A1 also shows a process for the production of a metal body which leads in a simple and reliable manner to the formation of a defined surface topography, optionally also combined in the range from 10 nm to 500 μm, on a metal base body or blank, which in particular is to have nanoscopic pores. For this purpose, a metal base body is subjected to a pulsating current in an electrolysis bath, the electrolysis bath being mixed with salt-forming ions matched to the material of the metal base body. Furthermore, a dental implant with particularly advantageous surface properties is to be presented, in which a nanostructure is superimposed on a superficial microstructure, and in which nitrogen atoms and/or nitrogen compounds are attached and/or enclosed in the region of the surface.

DE 10 2006 004 653 A1 discloses a process for the production of a metal body with a surface having nanoscopic pores or a nanoscopic structure, in which a metal base body is subjected to a pulsating current in an electrolytic bath, the electrolytic bath being mixed with ions which each consist of an element from one of the main groups V to VII of the periodic table of the elements or comprise such an element as a constituent. The metal base body may consist of titanium or of an alloy containing titanium, in particular mixed with chromium.

Common features of the etching process according to the present invention and of the etching process according to the DE 10 2006 004 653 A1 are listed below, namely:

An electrochemical cell with titanium and/or a titanium alloy and/or NiTi component is connected as an anode (cf. [0032]). In addition, etching is performed with an aqueous electrolyte solution containing chlorine ions (cf. [0032]).

Differences between the etching processes lie in the fact that the chlorine ion concentration is formed differently. Thus, on this side of the invention, the chlorine ion concentration is at a concentration or equivalent concentration in the range of 3 to 7 wt % [wt %] NaCl in water or 5 wt % [wt %] NaCl in water. In the publication, section [0032] selects as the electrolyte an aqueous solution of 30 ml of water and 5 g of sodium chloride or of 5 g of ammonium chloride and 30 ml of water. The chlorine ion concentration in the publication is thus clearly higher than the chlorine ion concentration according to the present invention.

Furthermore, on this side of the invention, active electrolyte circulation takes place during structuring. In the DE 10 2006 004 653 A1 publication, on the other hand, there is no active electrolyte circulation (see FIG. 2, [0030]).

In particular, in the publication in section [0032], a rectangular voltage signal pulsating between 0 V or lower and a maximum value is applied between the anode and the cathode at a frequency of 1 Hz. The maximum value is increased from 5 volts to 30 volts in successive time intervals of 5 minutes each in 5 V increments. This is completely opposite to the present method according to the invention in which the etching process time is run in the range of 1 to 60 seconds or in the range of 10 to 40 seconds or in the range around 30 seconds.

Consequently, also with the etching process according to the publication, no structure according to the structure according to the present invention with a first partial surface of titanium and/or titanium alloy and/or NiTi is obtained which is free of hydrogen-containing phases at least in the region of the anchoring layer, i.e. in the surface region of the titanium body.

In particular, the surface structure of the titanium surface according to the present invention after the etching process also differs significantly from the structure obtained according to the DE 10 2006 004 653 A1.

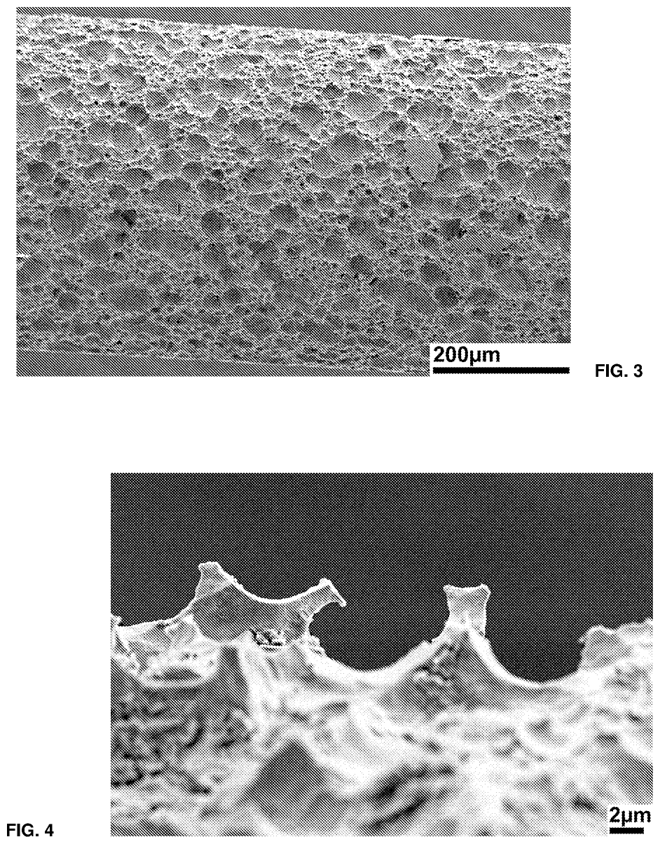

Furthermore, FIGS. 3 to 10 of the publication show that there are no predominant invaginations with a rounded oval shape with a minimum size of 1 micrometer corresponding to the structure according to the invention on this side, the surface having either smooth or scale-like surface texturing.

The clearly deviating process thus continues to obtain an etched, but nevertheless clearly differently textured titanium surface.

### FURTHER STATE OF THE ART

In addition, the state of the art includes non-wet-chemically produced structuring by means of plasma and laser, which, however, do not generate undercut structures in the titanium surface, but rather chemically activate the surface (plasma) or remelt it close to the surface, leaving small melt burrs (laser) on the surface.

The known wet chemical solutions, except for the solution according to the EP 3 175 018 B1, have the disadvantage that only the surface roughness and thus the contact area to the polymer is increased. However, this does not create undercut structures in the Ti/Ti alloy surface that mechanically anchor the polymer to the Ti/Ti alloy surface. Under mechanical loading, both static and cyclic, this leads to delamination or adhesive failure of the polymer on the Ti/Ti alloy surface, not only in the initial state, but also after corresponding aging, such as hot humidity, media exposure, etc.

Furthermore, the known wet-chemical solutions, including the solution from EP 3 175 018 B1, have the disadvantage that they lead to hydrogen embrittlement of the Ti/Ti alloy component, both in acidic and alkaline media.

It is generally known that the hydrogen produced during etching with non-oxidizing acids such as hydrochloric acid (HCl) can be bound by the titanium in the form of titanium hydride and thus lead to embrittlement of the material.

Hydrogen embrittlement is a glaring disadvantage, especially for Ti/Ti alloy components subjected to high mechanical loads, as this can in some cases reduce the mechanical properties of the Ti/Ti alloy to such an extent that they can fail or lead to cracks/fractures even under low static or dynamic mechanical loads. This is particularly catastrophic for NiTi as a shape memory material, since >10\hat{ }6 shape changes with very strong strains occur here in the application. Examples of applications include: Shape memory wire networks embedded in fiber composite materials for e.g. wing flaps in aerospace. In principle, hydrogen embrittlement is bad for the reliability of such Ti/Ti alloy-polymer composites, since the composite can also fail close to the surface within the Ti component due to this.

Ti-oxides are built up on Ti/TI alloy by electrochemical routes known so far. These can be formed either as layers, pores or nanotubes. The disadvantage of all these Ti oxide variants is that Ti oxide is a ceramic. Under mechanical load, e.g. by stretching, cracks occur in the ceramic due to its brittle behavior. This then leads to delamination of the polymer layer together with the Ti oxide layer from the Ti/Ti alloy substrate.

Plated or laser-structured Ti/Ti alloy surfaces do not have undercut structures in the surface, but at most lead to increased surface roughness by means of lasers due to melt burrs. Therefore, adhesive failure also occurs here due to the lack of undercut structures.

It is generally known that the hydrogen produced during etching with non-oxidizing acids such as hydrochloric acid (HCl) can be bound by the titanium in the form of titanium hydride and thus lead to embrittlement of the material. However, hydrogen embrittlement, or the formation of titanium hydride, is a major disadvantage, particularly in the case of shape memory materials such as NiTi, since these function by changing the crystal structures. Hydrogen embrittlement and hydride formation disrupt this desired functionality.

The task of the invention disclosed here is to improve titanium/titanium alloy polymer composites.

These composites have a very wide range of applications, from simple two-layer systems to multilayer systems to, for example, wire mesh composites or coated wires.

In particular, the technology disclosed here improves on the prior art in EP 3 175 018 B1 in that no hydrogen-induced embrittlement of the structured Ti/Ti alloy occurs and, at the same time, mechanical undercut structures are introduced into the surface of the Ti/Ti alloy.

In addition, the processing time is drastically reduced from 10-24 h to a few seconds. Furthermore, the two-step structuring with photochemical support becomes obsolete. In addition, highly concentrated acid mixtures such as HCl and H2SO4 are no longer used or required for structuring, but instead salt water and electric current. This drastically reduces the chemical hazards during patterning and reduces the disposal of process chemicals to virtually zero.

This task is solved with a composite structure according to the main claim and an electrochemical etching manufacturing process according to the secondary claim.

A composite structure having:
at least a first partial surface of a structure and/or of a workpiece and/or of a layer comprising titanium and/or a titanium alloy and/or NiTi,
a polymer which is arranged at least partially or in sections on the first partial surface of the first structure and/or of the workpiece and/or of the layer,
a common anchoring layer, wherein
the polymer is bonded in the contact region to the titanium and/or to the titanium alloy and/or NiTi at least partially or in sections or in the region of the first partial surface, completely or entirely via the common anchoring layer and the composite structure is characterised in that
at most titanium and/or the aforementioned mixed crystals including the intermetallic phases of the titanium alloy and/or NiTi occur in the anchoring layer
the titanium and/or the titanium alloy and/or NiTi is free of hydrogen-containing phases at least in the region of the anchoring layer, so that the titanium and/or titanium alloy and/or NiTi shows no brittle fracture at least in the region of the first partial surface or completely under mechanical load;
any cut surface extending perpendicularly to the anchoring layer has at least one protuberance of polymer enclosed by titanium and/or titanium alloy and/or NiTi, said enclosed protuberances exhibiting a rounded oval shape with a minimum size of 1 μm, said surface exhibiting either smooth or scale-like surface texturing.

The Ti/Ti alloy and NiTi polymer composites presented herein are formed in such a way that adhesive failure between metal and polymer does not occur due to defective undercut structures in the Ti/Ti alloy/NiTi surface. A secondary condition, necessary in the opinion of the inventors, that no hydrogen embrittlement and no closed oxide layers be formed during the etching process is met, so that a durable composite structure is formed that is durable and not susceptible to brittle fracture.

The advantages of the corresponding Ti components as a composite of Ti and polymer can be summarized as follows:
the production of undercut structures in Ti/Ti alloys is produced without any hydrogen embrittlement due to processing, and the cyclic strength is not negatively affected
the mechanical properties of the composite are significantly improved, both statically and cyclically, as fracture in Ti regions is virtually eliminated by the lack of hydrogen embrittlement (when used as intended);
the mechanical properties, both static and cyclic, in the unstructured Ti areas are preserved
no thick oxide layer is deposited on the Ti material which leads to no multilayer interface between Ti/Ti alloy and polymer as a “weak interface” (a Ti oxide layer corresponds to a ceramic whose brittle mechanical behavior under stress can lead to a non-calculable failure fracture in the ceramic layer;
no adhesive failure at the Ti/Ti alloy-polymer interface compared to other composites, produced with conventional Ti surface processing methods, due to mechanical anchoring while avoiding hydrogen embrittlement (e.g. also in contrast to EP 3 175 018 B1)
no occurrence of hydrogen-containing phases in the vicinity of the structured Ti/Ti alloy or NiTi surface (proof of this property can be provided or confirmed, for example, by an XRD investigation);

The structure and/or workpiece and/or layer may be made of or may be a combination of: Solid sheet, perforated sheet, fabric, tube, wire, flat multilayer, wire mesh, strip, sphere.

The polymer may also have supplementary reinforcing fibers and/or fillers.

In a particular embodiment, the structure and/or the workpiece and/or the layer comprising titanium and/or a titanium alloy and/or NiTi can be completely enclosed by the polymer. This can be, for example, a wire or other form.

Further, particularly preferably, the thickness of the anchoring layer may be between 0.5 and 150 micrometers or between 3 and 60 micrometers.

A further preferred embodiment is given if
the structure and/or the workpiece and/or the layer comprising titanium and/or a titanium alloy and/or NiTi is free, at least on the first partial surface, from
inclusions and/or precipitates of other metals and/or
deposits of alkali metals, alkaline earth metals and/or aluminum and/or intermetallic phases and/or
mechanically strongly defective areas.

Furthermore, in one embodiment, the composite can be formed with the following properties:
the surface has a first roughness and a second roughness, wherein
the first roughness is given by depressions in the form of pores, the pores having a diameter in the range between 0.5 and 50 m and being open in the direction of the surface and closed in the direction of the workpiece and at least some of the pores having an undercut and
the second roughness is given by statistically distributed elevations and depressions in the range of 100 nm and less.

The electrochemical etching method for producing undercut structures on surfaces of titanium and/or titanium alloys and/or NiTi for mechanical coupling of a polymer for manufacturing a composite structure according to any of the preceding claims, is characterized in that
an electrochemical cell is connected to titanium and/or titanium alloy and/or NiTi component as anode;
an active electrolyte circulation is carried out during the patterning;
etching is carried out with an aqueous electrolyte solution with a chlorine ion concentration with a concentration or equivalent concentration in the range of 3 to 7 wt % [wt %] NaCl in water or 5 wt % [wt %] NaCl in water;
the current source is operated in the current density range of 1 A/cm² or greater for short etch process times in the range of 1 to 60 seconds or in the range of 10 to 40 seconds or in the range around 30 seconds, generally using the following scheme:
   higher current density with simultaneously smaller process time at the same electrolyte concentration.

The process disclosed here is much less expensive to carry out and faster, since strongly oxidizing acids can be dispensed with.

Surprisingly, the inventors found out that the quasi unbraked etching with high flow rates and high current densities according to the invention can suppress the passivation by adsorption of chloride ions on the surface and thus particularly positive results can be achieved.

The process according to the invention may further comprise the complementary step of enclosing the produced undercut structures by a flowable polymer at the surface-structured Ti/Ti alloy and/or NiTi surface. This can be a thermosetting, room temperature curing or solidifying thermoplastic or thermoset.

Coating can be carried out, for example, by means of immersion and/or spraying in initially flowable and subsequently curing polymer, e.g. thermosets and/or elastomers, but also thermoplastics. Furthermore, resin transfer molding (RTM of composites with structured Ti/Ti alloy inserts) is possible. Thermal spraying (also injection molding), powder coating, painting and the like are also useful as coating processes for the polymer.

The electrochemical structuring process for the surface Ti/Ti alloy with the formation of undercut structures takes place without hydrogen embrittlement and without a build-up of thick oxide layers, such as those formed during anodizing.

The advantages of the structuring process can be summarized in particular as follows:
no photochemical support of the structuring process is necessary, which means that structuring of complex structures is also possible;
short to very short processing times are possible for the production of undercut structures in Ti/Ti alloys or NiTi;
the use of salt water electrolytes instead of concentrated acid mixtures offers advantages in handling, use, application (occupational safety) as well as in the unproblematic disposal of the electrolyte;
no high voltages are required, as is the case, for example, with anodizing.

A non-restrictive minimal embodiment example for the production of structured Ti/Ti alloy or NiTi components may in particular comprise the following steps:
an electrochemical cell with Ti/Ti alloy component is connected as anode;
the current source supplies a wide current density range, e.g. 1 A/cm² for 30 s, whereby in general: a higher current density leads to shorter process times at the same electrolyte concentration
active electrolyte circulation takes place during patterning
the electrolyte temperature can be typically room temperature, but higher/lower T are also possible, which is again very advantageous overall, since the boundary conditions are extremely minimal;
the electrolyte has approx. 5 wt % [wt %] NaCl in water, where the Cl— concentration can also be provided via HCl or other chlorides; again, higher or lower concentrations are possible in interplay with current density and electrolyte flow rate.

The wording of the characterizing part “—the current source is run in the current density range of greater than/equal to 1 A/cm² at short etch process times in the range of 1 to 60 seconds or in the range of 10 to 40 seconds or in the range around 30 seconds, generally applying the following scheme, higher current density with simultaneously smaller process time at the same electrolyte concentration, where higher or lower concentrations are run in interplay with current density and electrolyte flow rate” does not mean that the electrolyte concentration must remain the same, but only that the higher current density leads to smaller process times if the electrolyte concentration remains unchanged. A change or an obligatory leaving of the electrolyte concentration at the same level is just not executed here and can also not be interpreted.

To produce the composite consisting of structured Ti/Ti alloy component and polymer, this can be done after the structuring has been carried out by means of the etching process presented here by dipping and/or coating the structured Ti/Ti alloy component with liquid, uncured polymer as a single-layer system or melting thermoplastic onto structured Ti/Ti alloy component.

Further, in a preferred embodiment, the chlorine ion concentration of the aqueous electrolyte can be provided via a selection from: NaCl, HCl, KCl, CaCl₂) and/or other chlorides can be adjusted or prepared.

In addition, higher or lower concentrations can preferably be run in interplay with current density and electrolyte flow rate.

It is now possible for the first time to perform anodic “nanoscale sculpturing” rapidly, doing so under conditions that avoid hydrogen embrittlement.

Accordingly, the conditions for anodic electropolishing and anodic “nanoscale sculpturing” differ significantly.

In the following, the invention is described with reference to the accompanying figures in the description of figures, whereby these are intended to explain the invention and are not necessarily to be regarded as limiting:

FIG. 1 shows a composite consisting of a structured Ti/Ti alloy component and a polymer, where a first surface is formed accordingly. An interface is formed between the polymer and the structured Ti/Ti alloy component.

FIG. 2 shows a composite consisting of a structured Ti/Ti alloy component and a polymer, where a first and a second surface are formed accordingly. A multilayer system is formed here, whereby the Ti/Ti alloy component can have any shape, e.g. plate, wire, sphere, braiding and the like.

FIG. 3 shows a surface structured according to the invention. The homogeneous undercut structures in the titanium or the titanium alloy surface can be clearly seen, which can then be coated with a functional coating of a polymer and thus form the composite structure shown in FIG. 1.

FIG. 4 shows a detail of the structured surface according to the invention.

1. A composite structure having:
at least a first partial surface of a structure and/or of a workpiece and/or of a layer comprising titanium and/or a titanium alloy and/or NiTi,
a polymer which is arranged at least partially or in sections on the first partial surface of the first structure and/or of the workpiece and/or of the layer,
a common anchoring layer,
wherein
the polymer is bonded in the contact region to the titanium and/or to the titanium alloy and/or NiTi at least partially or in sections or in the region of the first partial surface, completely or entirely via the common anchoring layer
and the composite structure is characterized in that
at most titanium and/or the aforementioned mixed crystals including the intermetallic phases of the titanium alloy and/or NiTi occur in the anchoring layer
the titanium and/or the titanium alloy and/or NiTi is free of hydrogen-containing phases at least in the region of the anchoring layer, so that the titanium and/or titanium alloy and/or NiTi shows no brittle fracture at least in the region of the first partial surface or completely under mechanical load;
any cut surface extending perpendicularly to the anchoring layer has at least one protuberance of polymer enclosed by titanium and/or titanium alloy and/or NiTi, said enclosed protuberances exhibiting a rounded oval shape with a minimum size of 1 μm, said surface exhibiting either smooth or scale-like surface texturing.

2. The composite structure according to claim 1, wherein the structure and/or the workpiece and/or the layer is at least one of: solid sheet, perforated sheet, fabric, tube, wire, flat multilayer, wire mesh, tape, sphere.

3. The composite structure according to claim 1, wherein the polymer comprises reinforcing fibers and/or fillers.

4. The composite structure according to claim 1, wherein the structure and/or the workpiece and/or the layer comprising titanium and/or a titanium alloy and/or NiTi is completely enclosed by the polymer.

5. A composite structure according to claim 1, wherein the thickness of the anchoring layer is between 0.5 and 150 micrometers or between 3 and 60 micrometers.

6. A composite structure according to claim 1, wherein
the structure and/or the workpiece and/or the layer comprising titanium and/or a titanium alloy and/or NiTi is free, at least on the first partial surface, from
inclusions and/or precipitates of other metals
and/or
deposits of alkali metals, alkaline earth metals and/or aluminum and/or intermetallic phases
and/or
mechanically highly defective regions.

7. A composite structure according to claim 1, wherein
the surface has a first roughness and a second roughness, wherein
the first roughness is given by depressions in the form of pores, the pores having a diameter in the range between 0.5 and 50 m and being open in the direction of the surface and closed in the direction of the workpiece and at least some of the pores having an undercut
and
the second roughness is given by statistically distributed elevations and depressions in the range of 100 nm and less.

8. An electrochemical etching method for producing undercut structures on surfaces of titanium and/or titanium alloys and/or NiTi for mechanical coupling of a polymer for manufacturing a composite structure according to claim 1, wherein
an electrochemical cell is connected to titanium and/or titanium alloy and/or NiTi component as anode;
an active electrolyte circulation is carried out during patterning;
etching is carried out with an aqueous electrolyte solution with a chlorine ion concentration with a concentration or equivalent concentration in the range of 3 to 7 wt % NaCl in water or 5 wt % NaCl in water;
the current source is operated in the current density range of 1 A/cm² or greater for short etching process times in the range of 1 to 60 seconds or in the range of 10 to 40 seconds or in the range around 30 seconds, generally using the following scheme:
higher current density with simultaneously smaller process time at the same electrolyte concentration.

9. The method according to claim 8, wherein the chlorine ion concentration of the aqueous electrolyte is provided via a selection from: NaCl, HCl, KCl, CaCl₂) and/or other chlorides.

10. The method according to claim 8, wherein higher or lower concentrations are run in interaction with current density and electrolyte flow rate.
